(19) United States
(12) Patent Application Publication
(10) Pub. No.: US 2007/0246677 A1
(43) Pub. Date: Oct. 25, 2007

(54) Exhaust gas recirculation valve having self-centering bushing

(76) Inventor: Raul A. Bircann, Penfield, NY (US)

Correspondence Address: Jimmy L. Funke, Esq.;Delphi Technologies, Inc., Mail Code 480410202, P.O. Box 5052, Troy, MI, 48007, US

(21) Appl. No.: 11/408,839

(22) Filed: Apr. 21, 2006

(51) Int. Cl. F16K 31/44

(52) U.S. Cl. 251/214

(57) ABSTRACT

A pintle-type valve having a valve body enclosing a chamber. A first port including a valve seat is formed in a first wall of the body. A bore formed in a second wall of the body receives a pintle bushing. The outer diameter of the bushing is less than the diameter of the bore such that the bushing has radial freedom of motion. A valve stem is disposed in a bore in the bushing. The bushing is radially centered by resilient elements within the body bore, preferably annular metal springs. The bushing includes a flange extending along an outer surface of the valve body for forming a seal at the outer bushing end. At the opposite end of the bushing, a retainer comprising a wave washer exerts compressive force to seal the flange against the body while permitting the bushing to float radially in response to radial forces.

### TECHNICAL FIELD

The present invention relates to pintle valves having a pintle bushing; more particularly, to exhaust gas recirculation (EGR) pintle valves for internal combustion engines; and most particularly, to such a valve wherein the pintle shaft bushing is radially moveable in the valve body and may be centered by the pintle shaft to relieve radial shaft forces.

### BACKGROUND OF THE INVENTION

Pintle valves are well known for use in controlling flow of fluids, and especially gases. One important use is for recirculating a portion of the exhaust gas from an internal combustion engine into the intake manifold thereof.

EGR valves are known to have either a linear solenoid actuator or a cam-driven rotary actuator for driving the pintle. In diesel-powered automotive applications, rotary actuation is becoming preferred over linear solenoid actuation because of generally higher force margins inherent in mechanical gearing and camming. A benefit of a rotary-actuated EGR valve is that it is positively actuated in both opening and closing directions. Further, in parked position when no exhaust gas flow is desired and the actuator may be de-energized, the valve is locked closed mechanically by the cam rather than by a closing spring as in a solenoid-actuated EGR valve.

Current gas flow valves typically include a valve pintle bushing pressed into a bore in a valve wall opposite the valve seat. Due to necessary tight clearances for the pintle in the bushing and the plurality of other components common to current EGR control valves, misalignment of the pintle and head with respect to the valve seat is virtually inevitable. The valve head must center itself in the seat, thereby exerting a radial load on a misaligned bushing which causes frictional drag on the pintle shaft as it moves through the bushing. Further, the actuating forces exerted by the camming mechanism of a rotary-actuated valve on the valve pintle are not coaxial with the pintle axis and thus a radial component is borne by the bushing, resulting in accelerated wear, leakage, and premature failure. The resultant radial forces are parasitic, and may render a valve inoperative or precipitate a bent or broken shaft condition. Significant leakage of gases to the exterior of the valve is especially undesirable because government regulations on untreated exhaust emissions are becoming ever stricter.

What is needed in the art is means for allowing a pintle shaft bushing to be radially floating and therefore self-aligning by the pintle shaft to reduce the power required to actuate the valve, to reduce wear on the bushing, and to reduce emissions from the valve.

It is a principal object of the present invention to reduce wear on a pintle valve bushing. Also, to reduce overall valve hysteresis and, therefore, improve valve efficiency.

It is a further object of the present invention to reduce exhaust leakage from an EGR valve.

### SUMMARY OF THE INVENTION

Briefly described, a pintle-type valve in accordance with the invention includes a valve body enclosing a chamber. A first port surrounded by an annular valve seat is provided in a first wall of the body. A second port defining a body bore is formed in a second and opposite wall of the body coaxially with the first port for receiving a pintle bushing from outside the valve body. The outer diameter of the bushing is less than the diameter of the body bore such that the bushing has radial freedom of motion. A valve pintle shaft, having an attached valve head for mating with the valve seat, is disposed in a close-fitting central bore in the bushing. The bushing is radially floating in the body bore and is default centered therein by one or more resilient elements surrounding the bushing, preferably a plurality of annular metal springs or similar compliant entities. The bushing has a flange extending along an outer surface of the valve body for forming a seal at the outer bushing end. At the opposite end of the bushing, a retainer comprising a thrust washer and retaining ring on the bushing captures a wave washer between the retainer and the valve body, thus exerting compressive sealing force on the flange against the valve body. The pintle extends into preferably a conventional rotary actuator which is bolted to the valve body. Alternatively, a linear solenoid actuator may be employed. The axial forces exerted by the wave washer against the inner surface of the valve body and by the flange against the outer surface of the valve body are selected such that the bushing seals against passage of gas past the outside of the bushing while still being permitted to float radially in response to radial forces exerted by the pintle shaft.

### BRIEF DESCRIPTION OF THE DRAWINGS

These and other features and advantages of the invention will be more fully understood and appreciated from the following description of certain exemplary embodiments of the invention taken together with the accompanying drawings, in which:

FIG. 1 is a front elevational cross-sectional view of a prior art cam-actuated poppet valve assembly;

FIG. 2 is a side elevational cross-sectional view of the prior art valve assembly shown in FIG. 1; and

FIG. 3 is an elevational cross-sectional view of a radially-compliant shaft bushing in accordance with the invention mounted in a valve body like that shown in FIGS. 1 and 2.

Corresponding reference characters indicate corresponding parts throughout the several views. The exemplification set out herein illustrates a currently-preferred embodiment of the invention, and such exemplification is not to be construed as limiting the scope of the invention in any manner.

### DESCRIPTION OF THE PREFERRED EMBODIMENTS

The novelty and advantages conferred by the invention may be better appreciated by first considering a prior art pintle-type valve actuated by a rotary-cam actuator.

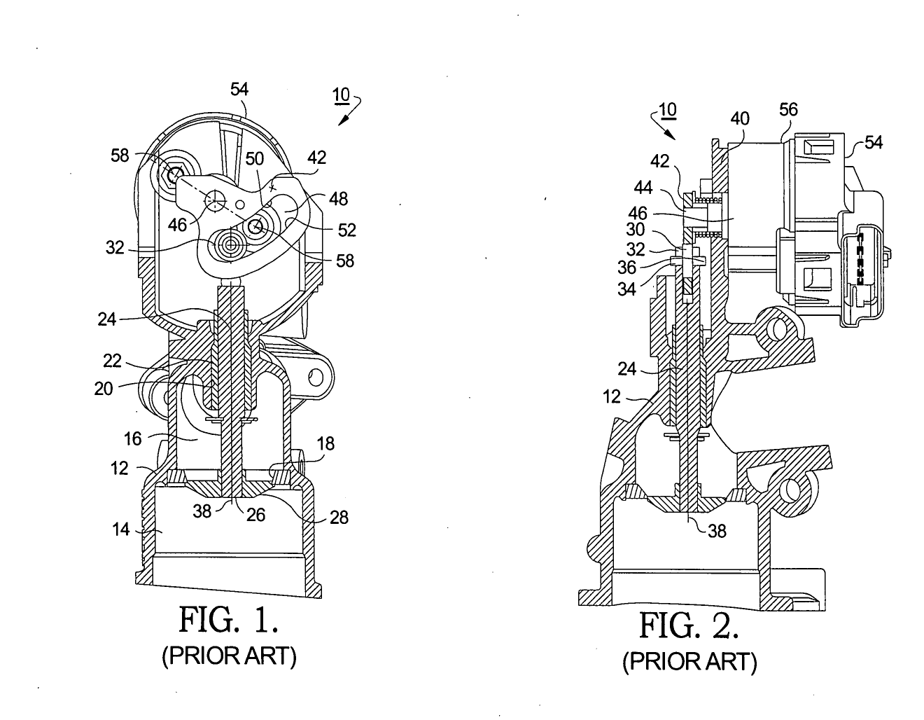

Referring to FIGS. 1 and 2, a prior art poppet valve assembly 10 suitable for use as an EGR valve comprises a valve body 12 defining a first chamber 14 and a second chamber 16 separated by a valve seat 18. A bore 20 in a wall of second chamber 16 is concentric with valve seat 18 and retains a bushing/seal 22 and a poppet valve stem 24 slidably disposed in bushing/seal 22. Stem 24 extends through second chamber 16 and fixedly supports, at a first end 26 within body 12, a valve head 28 for variably mating with valve seat 18 to variably open and close valve 10 between chambers 14,16 in response to axial motion of stem 24. At a second stem end 30 outside of body 12, stem 24 is provided with a roller 32 mounted on a first shaft 34 extending from stem 24 and having an axis 36 orthogonal to axis 38 of stem 24. A bracket 40 extending from body 12 supports a cam plate 42 mounted on a second shaft 44 extending from bracket 40 and also having an axis 46 orthogonal to, but preferably not intersective of, axis 38 of stem 24. Cam plate 42 includes a slot 48 having first and second slot sides 50,52 spaced apart by a distance very slightly greater than the diameter of roller 32 which is disposed within slot 48. Slot sides 50,52 spiral about axis 46. An electric motor 54 and optionally a gear transmission 56 is bolted to bracket 40 by bolts 58 such that second shaft 44 is, or is an extension of, the shaft of motor/transmission 54. It is seen that clockwise rotation of cam plate 42 about axis 46 by motor 54 from the valve-closed position shown in FIG. 1 causes stem 24 to be moved linearly in a direction toward first chamber 14, thus pulling valve head 28 from seat 18 and thereby opening valve assembly 10 between first and second chambers 14,16. Counterclockwise rotation of cam plate 42 causes valve assembly 10 to be closed.

It will be observed that slot side 50 drives roller 32 in valve-opening mode and slot side 52 drives roller 32 in valve-closing mode. Motor 54 may be de-energized at any point in the rotary travel of cam plate 42, locking the valve stem at that position.

As described above, when cam plate 42 is driven in rotation, slot sides 50,52 do not engage roller 32 along axis 38 but rather at an angle to axis 38. Thus, a torque is applied to valve stem 24 about an axis orthogonal to axis 38 urging a lateral shift in axis 38. It is an object of the invention to permit small amounts of such shifting of axis 38 within body 12 without permitting leakage from the valve or misalignment of the valve head with the valve seat. These shifts are accommodated through the deformation of the radial spring elements, which results in minimization of the transmitted radial loads and their accompanying detrimental effects of hysteresis and wear.

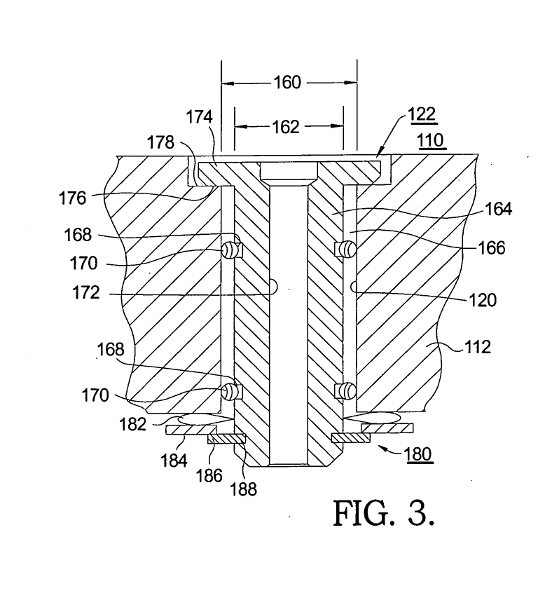

Referring to FIG. 3, an improved bushing 122 in accordance with the invention for use in a thus-improved pintle valve assembly 110 is shown disposed in a bore 120 in a pintle valve body 112. The diameter 160 of bore 120 is greater than the outer diameter 162 of the body 164 of bushing 122, defining thereby an annular space 166 therebetween for lateral shifting of the bushing within the valve body. Bushing body 164 is provided on its outer surface with first and second annular grooves 168 for receiving resilient spacers 170 that engage bore 120 to default center the bushing within the bore while also permitting lateral motion of the bushing as may be compelled by a valve stem (not shown but such as stem 24) disposed in axial bore 172 in bushing 122. Spacers 170 must be competent for the operating conditions of the valve, which precludes, because of elevated temperatures, the use of elastomers for an EGR valve wherein the preferred embodiment of spacers 170 is annular metal coil springs.

Bushing 122 includes a radial flange portion 174 having an axial surface 176 for sealingly mating with an axial surface 178 of valve body 112. The mating axial surfaces are urged into sealing engagement by an axial urging member 180 at the opposite end of bushing 122 wherein a compressible wave washer 182 is compressively captured by a flat washer 184 and a retaining ring 186 disposed in an annular groove 188 in bushing body 164.

In operation, resilient spacers 170 undergo radial compression and expansion to permit radial motion of bushing 122 within bore 120 as may be dictated by a valve stem that is close-fitting within bore 172. Arrangement 180 assures that a seal is maintained between radial surfaces 176,178 during such radial motion.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed is:

1. A pintle type valve assembly, comprising:
a) a valve body containing at least one chamber;
b) a valve seat in said chamber;
c) a port in said chamber opposite said valve seat, said port defining a body bore having a bore diameter;
d) a pintle stem bushing disposed in said body bore and having a first portion smaller in diameter than said body bore diameter defining an annular space therebetween and having a flange portion larger in diameter than said body bore diameter for axially sealing against said valve body;
e) a valve stem axially disposed in a stem bore in said bushing and extending into said chamber;
f) a valve head disposed on said stem for mating with said valve seat;
g) an actuator operably engaged with said valve stem for axial actuation thereof; and
h) at least one resilient spacer disposed in radial compression in said annular space for permitting radial motion of said bushing within said body bore.

2. A valve assembly in accordance with claim 1 further comprising an axial urging member disposed at an end of said bushing opposite from said flange portion for urging said flange portion into sealing contact with said valve body.

3. A valve assembly in accordance with claim 2
wherein said axial urging member includes a wave washer.

4. A valve assembly in accordance with claim 1 wherein said resilient spacer includes an annular metal spring.

5. A valve assembly in accordance with claim 1 wherein said valve is an exhaust gas recirculation valve.

6. A valve assembly in accordance with claim 1 wherein said actuator is selected from the group consisting of a linear solenoid and a motor-driven cam.

7. An internal combustion engine, comprising a pintle-type exhaust gas recirculation valve having
a valve body containing at least one chamber,
a valve seat in said chamber,
a port in said chamber opposite said valve seat, said port defining a body bore having a bore diameter,
a pintle stem bushing disposed in said body bore and having a first portion smaller in diameter than said body bore diameter defining an annular space therebetween and having a flange portion larger in diameter than said body bore diameter for axially sealing against said valve body,
a valve stem axially disposed in a stem bore in said bushing and extending into said chamber,
a valve head disposed on said stem for mating with said valve seat, an actuator operably engaged with said valve stem for axial actuation thereof, and
at least one resilient spacer disposed in radial compression in said annular space for permitting radial motion of said bushing within said body bore.
